(19) United States
(12) Patent Application Publication
(10) Pub. No.: US 2012/0159357 A1
(43) Pub. Date: Jun. 21, 2012

(54) MOBILE WEB MAP SERVICE SYSTEM AND TERMINAL PROVIDING MOBILE WEB MAP SERVICE

(75) Inventors: Young Jae LIM, Daejeon (KR); Ji Sang Park, Daejeon (KR); Sung Woong Shin, Daejeon (KR); Choul Ho Choi, Seoul (KR); Yeo Jin Kim, Seoul (KR)

(73) Assignees: KT Corporation, Seongnam-city (KR); Electronics & Telecommunications Research Institute, Daejeon (KR)

(21) Appl. No.: 13/327,748

(22) Filed: Dec. 15, 2011

(30) Foreign Application Priority Data
Dec. 16, 2010 (KR) 10-2010-0129444

(51) Int. Cl. G06F 3/048; G06F 3/01

(52) U.S. Cl. 715/760; 715/764

(57) ABSTRACT

The mobile web map service system includes a map server configured to provide map data to a terminal in response to a request from the terminal, a multimedia point of interest (mPOI) content provision server configured to provide multimedia information based on a geographic location represented by the map data in response to the request from the terminal, and a terminal configured to request and receive the map data and the multimedia information based on the geographic location represented by the map data, and output the received map data and multimedia information to a user. To overcome limitations of a conventional mobile web map service, a service can be configured using a service application programming interface (API) including hypertext markup language 5 (HTML5)-based geo-location, map-control, offline browsing, and mPOI functions.

### CLAIM FOR PRIORITY

This application claims priority to Korean Patent Application No. 2010-0129444 filed on Dec. 16, 2010 in the Korean Intellectual Property Office (KIPO), the entire contents of which are hereby incorporated by reference.

### BACKGROUND

1. Technical Field

Example embodiments of the present invention relate in general to a map service system, and more particularly, to a mobile web map service system enabling use of a map service on a web browser via the Internet in a mobile environment, and a terminal providing a mobile web map service.

2. Related Art

Recent proliferation of smartphones is causing a paradigm shift in the mobile communication industry from voice calls to applications, resulting in the advent of various mobile location-based service (LBS) applications that use location information about users.

Applications in a mobile environment are simply classified into native apps, mobile webs, hybrid apps, and so on. According to these categories, map services in a mobile environment may be classified into native app maps, mobile web maps, hybrid app maps, and so on. In native app maps that require different app programs according to various mobile devices, a variety of high-performance functions can be implemented. However, since different programs need to be developed according to terminals, development and maintenance cost is repeatedly required, and it is difficult to provide unified user experience (UX).

Meanwhile, mobile web maps are served using only an embedded web browser capable of accessing the Internet and thus easy for users to access. Also, various smartphones can provide the same UX by implementing one web service regardless of the type of smartphone, and when maintenance such as functional improvement is required, mobile web maps can be maintained with the latest version through code modification of a server.

On the other hand, one problem with existing mobile web maps is that map control user interfaces (UIs) are limited in function. With the development of web technology such as asynchronous JAVA script and extensible markup language (XML) (AJAX), map control UIs are being improved to enable map movement, enlargement/reduction, etc., but map rotation, etc. are still not possible. Also, a conventional mobile web map service can be used only when a browser is continuously connected to a web server via the Internet, and map data needs to be received online every time a map is browsed, resulting in the external use of a third generation (3G) network and communication cost for downloading a large amount of map data. Furthermore, an internal global positioning system (GPS) cannot be used with hypertext markup language (HTML) alone, and thus utilization of a map based on current location information is not possible. Moreover, additional plug-in programs need to be installed according to browsers to express various pieces of location-based multimedia content on maps.

### SUMMARY

Accordingly, example embodiments of the present invention are provided to substantially obviate one or more problems due to limitations and disadvantages of the related art.

Example embodiments of the present invention provide a mobile web map service system capable of providing as much abundant user experience (UX) as a native app map through a web browser without an additional plug-in.

Example embodiments of the present invention also provide a mobile web map service terminal capable of providing as much abundant UX as a native app map using hypertext markup language 5 (HTML5) through a web browser without an additional plug-in.

In some example embodiments, a mobile web map service system includes: a map server configured to provide map data to a terminal in response to a request from the terminal; a multimedia point of interest (mPOI) content provision server configured to provide multimedia information based on a geographic location represented by the map data in response to the request from the terminal; and a terminal configured to request and receive the map data and the multimedia information based on the geographic location represented by the map data from the map server and the mPOI content provision server, and output the received map data and multimedia information to a user.

The terminal may provide a mobile web map service to an application layer through service application programming interfaces (APIs) implemented on the basis of HTML5. Here, the service APIs may include API sets including: a geo-location category including at least one API for receiving input geographic information or information on a current location and direction from a positioning apparatus, and requesting and receiving map data corresponding to the current location from the map server; a map-control category including at least one API for performing at least one screen control among map movement, enlargement, reduction and rotation using the map data received through the API of the geo-location category; an offline browsing category including at least one API for receiving the map data from the map server and storing the received map data in an online state, and providing the stored map data in an offline state; and an mPOI category including at least one API for requesting and receiving the location-based multimedia content from the mPOI content provision server, and managing and outputting the location-based multimedia content. Here, the map-control category may include at least one API implemented using a screen display element of cascading style sheet (CSS).

The map server may transmit the map data requested by the terminal using a tile map service (TMS).

The map server may include: a base map database configured to store at least one piece of static data among aerial images, satellite images and digital maps, and dynamic data including traffic information as a base map; a map processing component configured to process and convert the base map into a service map that can be provided to the terminal; a service map database configured to store the service map; and a map provision component configured to transmit the service map as the map data to the terminal in response to the request of the terminal.

The terminal may automatically output the multimedia content that is about the geographic location on the map data received from the map server and received from the mPOI content provision server when the terminal moves close to the geographic location.

When the multimedia content about the geographic location on the map data received from the map server is present, the terminal may dispose a tag indicating the presence of the multimedia content to overlap or be adjacent to a location on the map data corresponding to the geographic location, and output the multimedia content by selection of the user.

In other example embodiments, a mobile web map service terminal requests and receives map data on a desired region or a current location from a map server, and multimedia information on a specific location on the map data from an mPOI content provision server, and outputs the received map data and multimedia information to a user, providing a mobile web map service to an application layer through service APIs implemented on the basis of HTML5.

Here, the service APIs may include API sets including: a geo-location category including at least one API for receiving input geographic information or information on the current location and a current direction from a positioning apparatus, and requesting and receiving map data corresponding to the current location from the map server; a map-control category including at least one API for performing at least one screen control among map movement, enlargement, reduction and rotation using the map data received through the API of the geo-location category; an offline browsing category including at least one API for receiving the map data from the map server and storing the received map data in an online state, and providing the stored map data in an offline state; and an mPOI category including at least one API for requesting and receiving the location-based multimedia content from the mPOI content provision server, and managing and outputting the location-based multimedia content. Here, the map-control category may include at least one API implemented using a screen display element of CSS.

### BRIEF DESCRIPTION OF DRAWINGS

Example embodiments of the present invention will become more apparent by describing in detail example embodiments of the present invention with reference to the accompanying drawings, in which:

FIG. 1 is a block diagram of a mobile web map service system according to an example embodiment of the present invention;

FIG. 2 a block diagram showing the constitution of a service application programming interface (API) of a terminal using a mobile web map service according to an example embodiment of the present invention;

FIG. 3 shows examples illustrating the concept of selective map data and multimedia point of interest (mPOI) content downloading during offline browsing of a hypertext markup language 5 (HTML5)-based service API according to an example embodiment of the present invention;

FIG. 4 is a flowchart illustrating a service scenario of offline browsing of an HTML5-based service API according to an example embodiment of the present invention; and

FIG. 5 shows an example of map data and mPOI content output through a mobile web map service according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, example embodiments of the present invention will be described in detail with reference to the appended drawings. That is, the entire constitution of a mobile web map service system according to an example embodiment of the present invention, and the constitution of a terminal according to an example embodiment of the present invention which is the core of the mobile web map service system will be described.

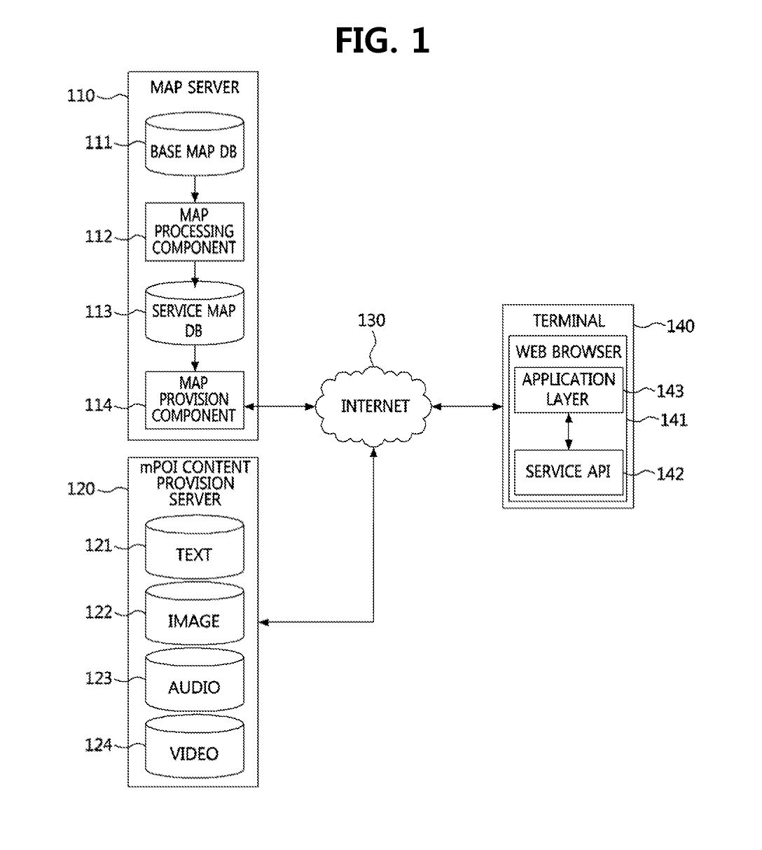

FIG. 1 is a block diagram of a mobile web map service system according to an example embodiment of the present invention.

Referring to FIG. 1, a mobile web map service system 100 according to an example embodiment of the present invention includes a map server 110 that provides map data, a multimedia point of interest (mPOI) content provision server 120 that provides location-based multimedia content, and a terminal 140 that requests map data and multimedia information from the map server 110 and the mPOI content provision server 120 via the Internet 130, and receives and outputs the requested data to a user.

The map server 110 is a component providing map data to the terminal 140 in response to a request from the terminal 140, and the mPOI content provision server 120 is a component providing mPOI based on a geographic location represented by the map data in response to the request from the terminal 140. The map server 110 and the mPOI content provision server 120 are merely named according to performed functions, and do not have to be implemented into physically separated hardware or software. In other words, the map server 110 and the mPOI content provision server 120 may be implemented into different pieces of software, implemented in the same hardware device, or two functional modules operating in one piece of software.

The terminal 140 is a component requesting and receiving map data and multimedia information based on a geographic location represented by the map data from the map server 110 and the mPOI content provision server 120, and outputting the received map data and multimedia information to the user. Here, the terminal 140 may be a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also a portable unit or terminal having a combination of such functions.

The configuration of the respective components of the system 100 will be described below. However, the configuration of the components described below is merely an example, and the detailed configuration of the components is not limited to the description below.

First, the map server 110 may include a base map database 111 storing a base map including static data, such as aerial images, satellite images and digital maps, and dynamic data including traffic information, a map processing component 112 processing the base map in the form of a service map that can be provided through an Internet browser, a service map database 113 storing the service map generated by the map processing component 112, and a map provision component 114 transmitting the service map to the terminal 140 via the Internet 130 in response to a request from the terminal 140.

Here, map processing and provision may be generally performed according to a tile map service (TMS) of processing a map in the form of tiles in advance, and providing the processed map through a browser. The map server 110 may provide map data to the terminal 140 according to a generally-used web map provision method other than the TMS.

The mPOI content provision server 120 is a component for disposing mPOI information, which is various pieces of location-based multimedia content, to overlap or be adjacent to a geographic location on a map as descriptive data on the geographic location, and providing the mPOI information to a user.

In the mPOI content provision server 120, information on a specific location is stored and managed by a service provider or general user in the form of a text 121 and an image 122, and as various pieces of multimedia content such as audio 123 and video 124. The stored location-based mPOI content is provided when the user selects the content, or the terminal 140 moves close to the corresponding location. In other words, the terminal 140 may dispose a tag indicating the presence of multimedia content about a geographic location on map data received from the map server 110 to overlap or be adjacent to a location on the map data corresponding to the geographic location when the multimedia content about the geographic location is present, and may output (play) the multimedia content when the user selects the tag by a clicking, touching, etc. operation. Also, the terminal 140 may automatically output the multimedia content that is about the geographic location on the map data received from the map server 110 and received from the mPOI content provision server 120 when it is sensed that the current location of the terminal is close to the geographic location.

Through an embedded web browser 141, the terminal 140 provides the above-mentioned service of browsing map information and mPOI content information to the user. To this end, the terminal 140 using a mobile web map service according to an example embodiment of the present invention is configured to provide the mobile web map service to an application layer 143 through service APIs 142 implemented using HTML5.

The detailed constitution of the service APIs 142 that the terminal 140 has will be described below.

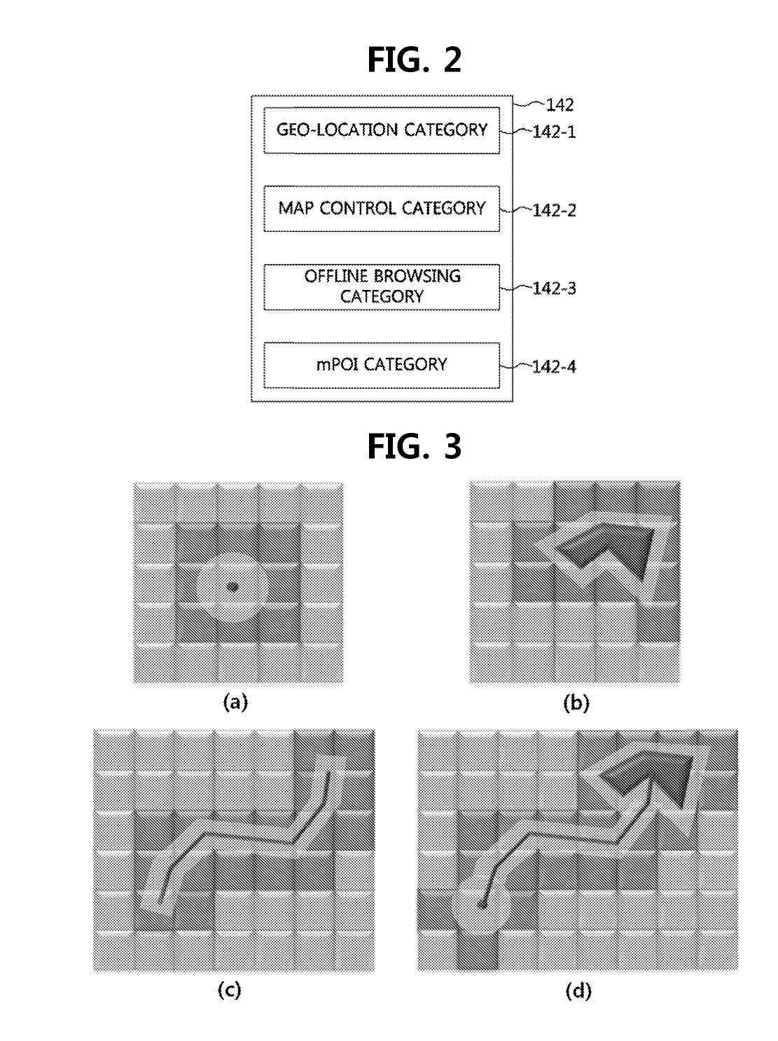

FIG. 2 a block diagram showing the constitution of a service application programming interface (API) of a terminal using a mobile web map service according to an example embodiment of the present invention.

Referring to FIG. 2, service APIs 142 according to an example embodiment of the present invention may consist of main function categories classified into a geo-location API set 142-1, a map-control API set 142-2, an offline browsing API set 142-3, an mPOI API set 142-4, and other API sets each including at least one API.

The service APIs 142 are implemented on the basis of hypertext markup language 5 (HTML5). As a proposed next standard for HTML 4.01, extensible HTML (XHTML), and document object model (DOM) level 2, HTML5 is the core markup language of World Wide Web (WWW) aimed at reducing necessity for Internet applications based on plug-ins such as Adobe Flash, Microsoft Silverlight, and Sun Java FX. Alternatively, the service APIs 142 may be implemented on the basis of cascading style sheet (CSS). As a language used to describe how a markup language is actually displayed, CSS is mainly used in conjunction with HTML and XHTML, and may also be used in conjunction with extensible markup language (XML). In particular, CSS3, the latest version having the increased degree of freedom for defining a layout and style, may be used.

APIs that can be included in the service APIs 142 will be described below in order of functional categories of the APIs. However, the categories of the service APIs 142 described below are merely classified according to functions, and API sets do not have to be classified according to only names described below. Also, APIs included in different categories of the service APIs 142 described below may call each other to perform the final operation.

First, the geo-location category 142-1 may receive current location and direction information from a positioning apparatus (a global positioning system (GPS), an electronic compass, an acceleration sensor, a wireless fidelity (WiFi) measurement scheme, etc.) as well as geographic information input by a user or input to search for a place name, and provide a map image tile corresponding to the current location and APIs to be used for browsing location-based mPOI content.

Next, by additionally using abundant screen display elements of CSS (particularly, CSS3) the map-control category 142-2 implements functions such as map rotation as well as gradual map movement, enlargement and reduction that are partially available in a conventional web map service.

Next, the offline browsing category 142-3 may provide an offline browsing function to constantly provide the corresponding map service in an offline state in which the Internet is not connected as well as an online state.

The offline browsing function stores a map image tile and mPOI content of the corresponding region or route in advance in a state in which Internet connection, such as Institute of Electrical and Electronic Engineers (IEEE)802.11 WiFi or third generation (3G) and fourth generation (4G) wireless Internet service, is enabled, and enables constant use of the map image tile and the mPOI content even in the offline state. Here, due to limitations of a memory in a terminal, etc., it is impossible to ensure sufficient map image tiles and mPOI content information for an offline service. Thus, it is required to select and download data to be stored in a local storage in advance using an area query operator.

FIG. 3 shows examples illustrating the concept of selective map data and mPOI content downloading during offline browsing of an HTML5-based service API according to an example embodiment of the present invention.

Referring to FIG. 3, a map image tile of a specific location may be searched for by selecting map image tiles (dark brown tiles) included in a range (yellow area) from the location (red) as shown in FIG. 3(A), and likewise, map image tiles of a specific area (FIG. 3(b)) and route (FIG. 3(c)) may be searched for by selecting map image tiles included in a range from the area and route. Also, as shown in FIG. 3(d), the corresponding map image tiles may be searched for using a combination of unit query operators used above according to an application example.

By use of HTML5-related functions, map image tiles and location-based mPOI content selected using such an area query operator are stored in a local storage of predetermined size ensured by an embedded web browser of a mobile terminal in the online state, and loaded and browsed in the offline state, so that a map service can be constantly provided. Also, since the local storage of the mobile terminal is limited in capacity, the offline browsing service API category 142-3 may include APIs providing a function of calculating and managing lifetimes and estimated capacity of map image tiles and mPOI content files, and security functions of managing copyright of content, and so on.

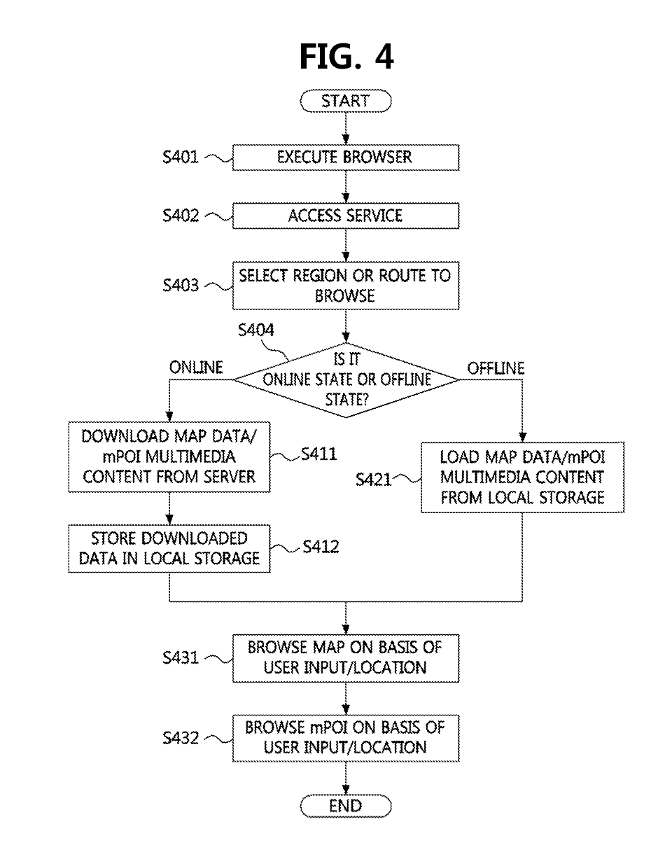

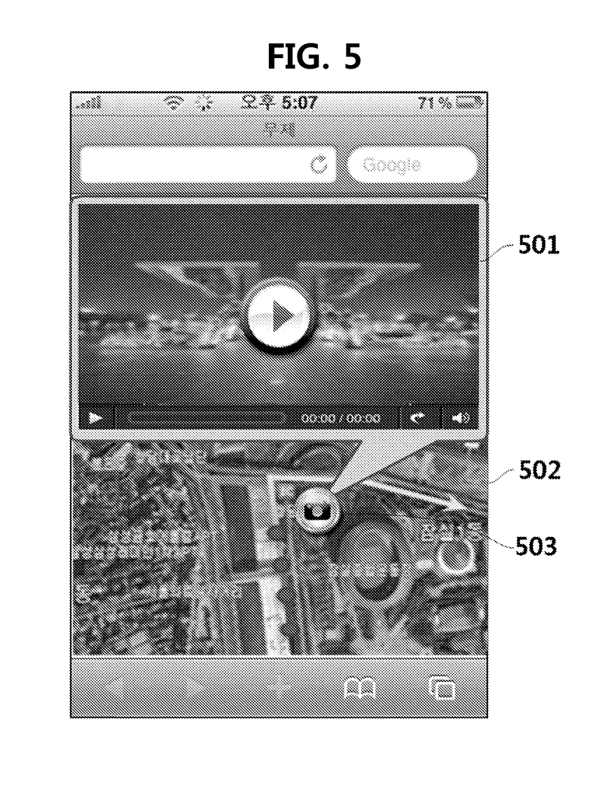

FIG. 4 is a flowchart illustrating a service scenario of offline browsing of an HTML5-based service API according to an example embodiment of the present invention.

A mobile terminal of a user may be currently in an environment in which wireless Internet access is available. When the user wants to use a mobile web map service even in a region in which wireless Internet access is unavailable, or the fee for Internet use is high (i.e., 3G wireless Internet, etc.), the following scenario may be taken into consideration.

Referring to FIG. 4, the user executes a web browser embedded in the mobile terminal (S401), and accesses a service provided by the corresponding service provider (S402). In other words, by inputting a uniform resource locator (URL) of a map server that provides a mobile web map service, it is possible to access the map service.

Subsequently, the user selects a region or route that he/she wants to visit (S403).

Thereafter, it is determined whether to use an offline browsing function or an online browsing function according to whether the terminal is currently in an online state in which Internet access is available, or an offline state in which Internet access is unavailable (S404), and then different procedures are followed.

First, when the terminal is currently in the online state in which Internet access is available, map image tiles and mPOI content elements corresponding to the region or route are retrieved from the corresponding server using a combination of area query operators (S411), and output on the web browser and stored in a local storage at the same time (S412). At this time, the user may browse the region to visit in advance by moving, enlarging/reducing, and rotating a map using a touch operation, etc. on a browser screen (S431), and may also select and check mPOI in advance (S432).

Meanwhile, when the terminal is currently in the offline state in which Internet access is unavailable, map data and mPOI multimedia content are not received from the server, but the corresponding map and mPOI data stored in advance are obtained from the local storage and output to the browser (S421). At this time, if location and direction information is available, map browsing such as map movement and rotation is performed by movement of the user (S431), and the corresponding mPOI content is played on the basis of the location and direction information when the user comes close to specific mPOI (S432).

As the last functional category of the service APIs 142, the mPOI category 142-4 is an API category providing a function of managing and outputting mPOI that is various pieces of location-based multimedia content. When a user selects a marker indicating a location of the corresponding content on a map, or it is determined that adjacent mPOI is present according to current location information obtained by the geo-location category 142-1, the mPOI is automatically browsed on the map.

To output such multimedia content, a conventional web map service requires plug-in elements installed in advance in each web browser. On the other hand, in an example embodiment of the present invention, HTML5-related functions enable browsing and control of multimedia content through a web browser alone.

FIG. 5 shows an example of map data and mPOI content output through a mobile web map service according to an example embodiment of the present invention.

Referring to FIG. 5, if mPOI registered around a current location is present 503 when a map 502 is automatically browsed according to movement of a user who is being provided with a map service through a web browser, the mPOI content is automatically output 501 on the map.

In other words, when a terminal senses that the current location of the terminal is moved close to a geographic location on map data received from a map server, multimedia content that is about the geographic location and received from an mPOI content provision server is automatically output.

As described above, when multimedia content about a geographic location on map data received from the map server is present, the terminal may dispose a tag indicating the presence of the multimedia content to overlap or be adjacent to a location on the map data corresponding to the geographic location, and output (play) the multimedia content when the user selects the tag by a clicking, touching, etc. operation.

Also, direction information about a smartphone terminal may be obtained with location information using a geo-location function. Thus, when the direction of the terminal is turned to an mPOI registration spot around the mPOI registration spot, an output state of content may be adaptively changed, such as automatic play of video and a gradual increase in audio volume, according to the direction information.

In the above-described mobile web map service system according to example embodiments of the present invention, it is possible to find the current location of a terminal through browser-based web access, and provide a map service such as map browsing and output of location-based multimedia content using an HTML5-based mobile web map service that is implemented by use of techniques provided by HTML5.

In particular, various map control functions such as map rotation are enabled, and the same map utilization function is available offline as well as online in consideration of a mobile environment in which use of the Internet is limited. Also, location-based content in various forms of multimedia can overlap a map and be provided to a user without an additional plug-in.

While the example embodiments of the present invention and their advantages have been described in detail, it should be understood that various changes, substitutions and alterations may be made herein without departing from the scope of the invention.

What is claimed is:

1. A mobile web map service system, comprising:
a map server configured to provide map data to a terminal in response to a request from the terminal;
a multimedia point of interest (mPOI) content provision server configured to provide multimedia information based on a geographic location represented by the map data in response to the request from the terminal; and
a terminal configured to request and receive the map data and the multimedia information based on the geographic location represented by the map data from the map server and the mPOI content provision server, and output the received map data and multimedia information to a user.

2. The mobile web map service system of claim 1, wherein the terminal provides a mobile web map service to an application layer through service application programming interfaces (APIs) implemented on the basis of HTML5.

3. The mobile web map service system of claim 2, wherein the service APIs include API sets including:
a geo-location category including at least one API for receiving input geographic information or information on a current location and direction from a positioning apparatus, and requesting and receiving map data corresponding to the current location from the map server;
a map-control category including at least one API for performing at least one screen control among map movement, enlargement, reduction and rotation using the map data received through the API of the geo-location category;
an offline browsing category including at least one API for receiving the map data from the map server and storing the received map data in an online state, and providing the stored map data in an offline state; and
an mPOI category including at least one API for requesting and receiving the location-based multimedia content from the mPOI content provision server, and managing and outputting the location-based multimedia content.

4. The mobile web map service system of claim 3, wherein the map-control category consists of at least one API implemented using a screen display element of cascading style sheet (CSS).

5. The mobile web map service system of claim 1, wherein the map server transmits the map data requested by the terminal using a tile map service (TMS).

6. The mobile web map service system of claim 1, wherein the map server includes:
a base map database configured to store at least one piece of static data among aerial images, satellite images and digital maps, and dynamic data including traffic information as a base map;
a map processing component configured to process and convert the base map into a service map that can be provided to the terminal;
a service map database configured to store the service map; and
a map provision component configured to transmit the service map as the map data to the terminal in response to the request of the terminal.

7. The mobile web map service system of claim 1, wherein the terminal automatically outputs the multimedia content that is about the geographic location on the map data received from the map server and received from the mPOI content provision server when the terminal moves close to the geographic location.

8. The mobile web map service system of claim 1, wherein, when the multimedia content about the geographic location on the map data received from the map server is present, the terminal disposes a tag indicating presence of the multimedia content to overlap or be adjacent to a location on the map data corresponding to the geographic location, and outputs the multimedia content by selection of the user.

9. A terminal providing a user with a mobile web map service of requesting and receiving map data on a desired region or a current location from a map server, and multimedia content on a specific location on the map data from a multimedia point of interest (mPOI) content provision server, and outputting the received map data and multimedia information to the user, wherein the mobile web map service is provided to an application layer through service application programming interfaces (APIs) implemented on the basis of hypertext markup language 5 (HTML5), and
the service APIs include API sets including:
a geo-location category including at least one API for receiving input geographic information or information on the current location and a current direction from a positioning apparatus, and requesting and receiving map data corresponding to the current location from the map server;
a map-control category including at least one API for performing at least one screen control among map movement, enlargement, reduction and rotation using the map data received through the API of the geo-location category;
an offline browsing category including at least one API for receiving the map data from the map server and storing the received map data in an online state, and providing the stored map data in an offline state; and
an mPOI category including at least one API for requesting and receiving the location-based multimedia content from the mPOI content provision server, and managing and outputting the location-based multimedia content.

10. The terminal of claim 9, wherein the map-control category consists of at least one API implemented using a screen display element of cascading style sheet (CSS).

11. The terminal of claim 9, wherein the requested map data is received from the map server using a tile map service (TMS).

12. The terminal of claim 9, wherein multimedia content that is about the geographic location on the map data received from the map server and received from the mPOI content provision server is automatically output when the terminal moves close to the geographic location.

13. The terminal of claim 9, wherein, when the multimedia content about the geographic location on the map data received from the map server is present, a tag indicating presence of the multimedia content is disposed to overlap or be adjacent to a location on the map data corresponding to the geographic location, and the multimedia content is output by selection of the user.
